(19) United States
(12) Patent Application Publication
(10) Pub. No.: US 2005/0021721 A1
(43) Pub. Date: Jan. 27, 2005

(54) Device troubleshooting request system, troubleshooting request server, device troubleshooting request program, and device troubleshooting requesting method

(76) Inventors: Yusuke Takahashi, Suwa-shi (JP); Toru Takahashi, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/857,610

(22) Filed: May 28, 2004

(30) Foreign Application Priority Data
May 30, 2003 (JP) 2003-155891

(51) Int. Cl. G06F 15/173

(52) U.S. Cl. 709/223

(57) ABSTRACT

A method is provided that includes selecting a desired person to be requested to carry out troubleshooting from plural requestable persons on the basis of trouble information of a problem that has occurred in a device, notifying a request destination user terminal of the desired person that the problem has occurred, judging whether troubleshooting has been completed or not on the basis of a response from the request destination user terminal, selecting a new desired person to be requested to carry out troubleshooting if troubleshooting has not been completed, and notifying a request destination user terminal of the new desired person that the trouble has occurred.

### RELATED APPLICATIONS

This application claims priority to Japanese Patent Application No. 2003-155891 filed May 30, 2003 which is hereby expressly incorporated by reference herein in its entirety.

### BACKGROUND

1. Technical Field

The present invention relates to a device troubleshooting request system, a troubleshooting request server, a device troubleshooting request program, and a device troubleshooting requesting method. Particularly, it relates to a device troubleshooting request system, a troubleshooting request server, a device troubleshooting request program, and a device troubleshooting requesting method that realize reduction in down time due to errors and failures in a device such as a printer or copy machine utilizing a network.

2. Related Art

A device such as a printer or copy machine utilizing a network is provided with a system for monitoring troubles (problems, errors, failures, etc.) in the device in order to minimize the time period during which the device cannot be used because of the occurrence of troubles. When a problem occurs, the manager of the device is notified. However, in such a notification method, the manager is notified of all the troubles irrespective of what these troubles are. Therefore, the manager must grasp what the troubles are and make arrangement for recovery from the trouble. Thus, a troubleshooting requesting method that reduces the burden on the manager has been conventionally proposed.

JP-A-2002-152207 proposes a system for selecting a destination of a notification of a trouble (problem) from “manager on the user side”, “SI (system integrator) maintenance staff member who delivered the device” and “maintenance staff member on the manufacturer side” in accordance with the seriousness and the date and time of the trouble that has occurred in the device, and sending a troubleshooting notification appended with what the trouble is and/or a troubleshooting method to the selected destination of notification.

However, in the invention of JP-A-2002-152207, only the troubleshooting notification for the trouble that has occurred in the device is sent to the destination of notification, and no measure is taken for a person in charge at the destination of the notification to eliminate the trouble. That is, even if the troubleshooting notification is sent from the system to the destination of notification, the system or an administrator of the system cannot confirm whether recovery from the trouble has been carried out or not.

Moreover, the system does not grasp the troubleshooting state at the destination of notification to which the troubleshooting notification has been sent. Therefore, when the person in charge at the destination of notification cannot carry out troubleshooting for the trouble, for example, when the person in charge at the destination of notification is not present, there is a problem that recovery of the device by sending the troubleshooting notification to another destination of notification cannot be carried out. In view of the foregoing problems, it is an object of this invention to provide a device troubleshooting request system, a troubleshooting request server, a device troubleshooting request program, and a device troubleshooting request method that enable reduction in down time of the device due to troubles that occur in the device.

### SUMMARY

In order to solve the above-described problems of the conventional technique, the following is provided.

According to aspect 1, there is provided a device troubleshooting request system which has one or more devices as objects of monitoring for the occurrence of a trouble (problem) and plural user terminals used by plural requestable persons who can be requested to carry out a troubleshooting operation for a trouble (problem) that has occurred in the device, the devices and the user terminals being connected so that the devices and the user terminals can communicate with each other. The device troubleshooting request system is characterized by having troubleshooting request means for selecting a desired person to be requested to carry out the troubleshooting operation for the trouble from the plural requestable persons on the basis of trouble information of the trouble that has occurred in the device, notifying a request destination user terminal of the desired person, of the occurrence of the trouble, judging whether troubleshooting for the trouble has been completed or not on the basis of a response from the request destination user terminal, selecting a different desired person different to carry out the troubleshooting operation for the trouble when it is judged that troubleshooting has not been completed, and notifying the occurrence of the trouble to a request destination user terminal of the different desired person.

With such a structure, the troubleshooting request means selects a desired person to be requested to carry out a troubleshooting operation for a trouble (problem) from plural requestable persons on the basis of trouble information of the trouble that has occurred in the device, and notifies the occurrence of the trouble to a request destination user terminal, which is a user terminal used by the desired person. Moreover, whether troubleshooting for the trouble has been completed or not is judged on the basis of a response from the request destination user terminal with respect to the occurrence of the trouble that is notified of, and when it is judged that troubleshooting has not been completed, a different desired person who is different from the first desired person who was previously requested to carry out the troubleshooting operation for the trouble is selected. A request destination user terminal of the different desired person is notified of the occurrence of the trouble.

This enables confirmation of whether the desired person requested to carry out the troubleshooting operation has carried out the troubleshooting operation or not, on the basis of the response from the request destination user terminal. As the troubleshooting is securely carried out, it is possible to reduce down time of the device in which the trouble has occurred, compared with the conventional technique. Moreover, when the desired person requested to carry out the troubleshooting operation for the trouble that has occurred in the device cannot carry out troubleshooting, or when the desired person is not present, another desired person can be requested to carry out the troubleshooting operation. Therefore, it is possible to reduce down time of the device in which the trouble has occurred, compared with the conventional technique.

Furthermore, since general users are also requested to carry out troubleshooting for the trouble that has occurred, the burden of the troubleshooting operation on the relatively technically advanced requested persons such as a user in charge of management or maintenance staff member of the service center can be shared by general users. The requested (desired) person is at least one of general users using the device, a user in charge of management who has relatively advanced technical knowledge among general users and manages the device, an SI maintenance staff member who delivered the device, and a maintenance staff member at the service center of the manufacturer.

According to aspect 2, the device troubleshooting request system of aspect 1 is characterized in that the troubleshooting request means has trouble detection means for detecting device information for identifying the device in which the trouble has occurred and trouble information for identifying the type of trouble, troubleshooting request destination selection means for selecting the desired person to be requested to carry out a troubleshooting operation for the trouble from the plural requestable persons on the basis of the trouble information detected by the trouble detection means, troubleshooting request information sending means for sending troubleshooting request information to request for the troubleshooting operation for the trouble that has occurred in the device, to a request destination user terminal of the desired person, troubleshooting request destination monitoring means for monitoring a response from the request destination user terminal to which the troubleshooting request information has been sent by the troubleshooting request information sending means, and troubleshooting request destination reselection means for judging whether the troubleshooting has been completed or not on the basis of the response from the request destination user terminal and selecting a different desired person to carry out the troubleshooting operation for the trouble when it is judged that the troubleshooting has not been completed.

With such a structure, the trouble detection means detects device information of the device in which the trouble has occurred and trouble information of the trouble that has occurred, and the troubleshooting request destination selection means selects a desired person to carry out a troubleshooting operation for the trouble from plural requestable persons. The troubleshooting request information sending means sends troubleshooting request information to the request destination user terminal of the desired person. The troubleshooting request destination monitoring means monitors a response from the request destination user terminal with respect to the troubleshooting request information that has been sent. The troubleshooting request destination reselection means selects a different desired person (different from the desired person previously requested) to carry out the troubleshooting operation on the basis of the response from the request destination user terminal (for example, when the response from the request destination user terminal is a rejection response or when there is no response). The troubleshooting request information sending means sends the troubleshooting request information to the request destination user terminal of the different desired person.

This enables confirmation of whether the desired person requested to carry out the troubleshooting operation has carried out the troubleshooting operation or not, on the basis of the response from the request destination user terminal. As the troubleshooting is securely carried out, it is possible to reduce down time of the device in which the trouble has occurred, compared with the conventional technique. Moreover, when the desired person requested to carry out the troubleshooting operation for the trouble that has occurred in the device cannot carry out troubleshooting, or when the requested desired person is not present, another desired person can be requested to carry out the troubleshooting operation. Therefore, it is possible to reduce down time of the device in which the trouble has occurred, compared with the conventional technique.

Furthermore, since general users are also requested to carry out troubleshooting for the trouble that has occurred, the burden of the troubleshooting operation on the relatively technically advanced persons such as a user in charge of management or maintenance staff members at the service center can be shared by general users.

According to aspect 3, the device troubleshooting request system of aspect 2 is characterized in that the troubleshooting request means further has a troubleshooting request target person registration means for storing, in a predetermined storage unit, user information of the requested desired persons and information of the user terminal for selecting the desired person to be requested to carry out the troubleshooting operation for the trouble. The troubleshooting request destination selection means selects the desired person to be requested to carry out the troubleshooting operation for the trouble from the plural requestable persons on the basis of the trouble information and the user information. The troubleshooting request information sending means sends the troubleshooting request information to the request destination user terminal on the basis of the information of the user terminal corresponding to the selected desired person.

With such a structure, the troubleshooting request target person registration means stores, in the predetermined storage unit, user information of a requestable person and information of the user terminal for selecting a desired person to be requested to carry out the troubleshooting operation. The troubleshooting request destination selection means selects a desired person to be requested to carry out the troubleshooting operation from the plural requestable persons on the basis of the trouble information and the user information. The troubleshooting request information sending means sends the troubleshooting request information to the request destination user terminal on the basis of the information of the user terminal corresponding to the selected desired person.

This enables execution of registration, change, deletion and the like of user information and information of the user terminal of a requestable person who can be requested to carry out troubleshooting, from an arbitrary user terminal.

According to aspect 4, the device troubleshooting request system of aspect 2 or 3 is characterized in that the troubleshooting request destination selection means has request destination candidate search means for searching the plural requestable persons who can be requested to carry out the troubleshooting operation for the trouble from the plural requestable persons on the basis of the trouble information, request order decision means for deciding the order of requesting the plural requestable persons found as a result of searching by the request destination candidate search means to carry out the troubleshooting operation for the trouble, and request destination decision means for deciding the desired person to be requested to carry out the troubleshooting operation for the trouble on the basis of the request order decided by the request order decision means.

With such a structure, the request destination candidate search means selects requestable persons who can be requested to carry out troubleshooting. The request order decision means decides the order of requesting the requestable persons found by the search to carry out the troubleshooting operation. The request destination decision means decides the desired person to be requested to carry out the troubleshooting operation on the basis of the request order. This enables further reduction in down time of the device in which the trouble has occurred, for example, by making a notification order earlier to a desired person who can carry out troubleshooting in a shorter time or by making a notification order earlier to a general user who has experience which the required troubleshooting operation.

According to aspect 5, the device troubleshooting request system of aspect 4 is characterized in that the request destination candidate search means sets, in advance, a trouble level representing the seriousness of each of the troubles and a troubleshooting level representing the trouble level for which each of the requestable persons can carry out troubleshooting, and selects the desired person with a troubleshooting level corresponding to the trouble level of the trouble.

As this enables notification of a troubleshooting request corresponding to the troubleshooting level of the desired person, the troubleshooting operation is executed relatively securely. Therefore, it is possible to reduce down time of the device in which the trouble has occurred, compared with the conventional technique.

According to aspect 6, the device troubleshooting request system of aspect 4 is characterized in that the request order decision means makes a request order earlier to the desired person who used the device within a predetermined past time period and who used the device most recently.

Since the trouble occurred after the desired person used the device, the desired person is likely to be responsible for the trouble. Therefore, there is a high possibility that the desired person will agree to carry out troubleshooting and it is possible to further reduce down time of the device in which the trouble has occurred.

According to aspect 7, the device troubleshooting request system of aspect 4 is characterized in that the request order decision means acquires troubleshooting experience information representing the degree of a requestable person's troubleshooting experience for the trouble from predetermined storage means, and decides a request order to the requestable person on the basis of the acquired troubleshooting experience information.

Therefore, for example, if a requested person who has never experienced the troubleshooting operation is preferentially requested, the number of persons who have experienced the troubleshooting operations increases and later troubleshooting operations are carried out relatively securely, making it possible to further reduce down time of the device in which the trouble has occurred. Moreover, for example, if a requested person who has experienced troubleshooting is preferentially notified of the trouble, the troubleshooting operation is carried out relatively securely and easily, making it possible to further reduce down time of the device in which the trouble has occurred.

According to aspect 8, the device troubleshooting request system of aspect 2 or 3 is characterized in that the troubleshooting request destination reselection means selects a different desired person (different from the person already requested) to carry out the troubleshooting operation for the trouble on the basis of the request order decided by the request order decision means when the response from the request destination user terminal to which the troubleshooting request information for the trouble has been sent is a rejection response or when there is no response from the request destination user terminal after the lapse of a predetermined time.

This enables another person to be requested when the person originally requested to carry out the troubleshooting for the trouble that has occurred in the device cannot carry out troubleshooting or when the first requested person is not present. Therefore, it is possible to reduce down time of the device in which the trouble has occurred, compared with the conventional technique.

According to aspect 9, the device troubleshooting request system of aspect 2 or 3 is characterized in that the troubleshooting request destination reselection means selects a different person to carry out the troubleshooting operation for the trouble on the basis of the request order decided by the request order decision means when there is no response showing completion of troubleshooting for the trouble from the request destination user terminal after a lapse of a predetermined time even if the response from the request destination user terminal to which the troubleshooting request information for the trouble has been sent is an agreement response.

This enables confirmation of whether or not the person initially requested to carry out the troubleshooting operation carried out the troubleshooting operation on the basis of the response from the request destination user terminal. Therefore, since the troubleshooting operation is securely carried out, it is possible to reduce down time of the device in which the trouble has occurred, as compared with the conventional technique.

According to aspect 10, the device troubleshooting request system of aspect 2 or 3 is characterized in that the troubleshooting request destination reselection means selects a new person that is different from the person initially requested to carry out the troubleshooting operation for the trouble on the basis of a request search condition made by the initially requested person and appended to a rejection response when the response from the request destination user terminal to which the troubleshooting request information for the trouble has been sent is a rejection response.

This enables consideration of the initially requested person's opinion and judgment in the search for the next requested person. As the person that can carry out the troubleshooting operation relatively securely is found by the search, it is possible to reduce down time of the device in which the trouble has occurred. For example, by considering a request search condition to select a person of a higher troubleshooting level in the case where a person of the same level as the currently requested person cannot carry out troubleshooting for the trouble, it is possible to search for a person who can carry out the troubleshooting operation relatively securely and to further reduce down time of the device in which the trouble has occurred.

According to aspect 11, the device troubleshooting request system of aspect 2 or 3 is characterized in that the troubleshooting request destination reselection means selects a new person designated by the initially requested person and appended to a rejection response when the response from the request destination user terminal to which the troubleshooting request information for the trouble has been sent is a rejection response.

This enables consideration of the initially requested person's opinion and judgment in the search for the next requested person. As the person who can carry out the troubleshooting operation relatively securely is found by the search, it is possible to further reduce down time of the device in which the trouble has occurred.

According to aspect 12, the device troubleshooting request system described in one of aspects 8 to 11 is characterized in that the troubleshooting request destination reselection means selects plural requestable persons that are different from the initially requested person requested to carry out the troubleshooting operation for the trouble.

This enables execution of the troubleshooting operation by the plural requestable persons and further reduces down time of the device in which the trouble has occurred.

According to aspect 13, there is provided a troubleshooting request server connected to one or more devices as objects of monitoring for the occurrence of a trouble (problem) and to plural user terminals used by plural requestable persons who can be requested to carry out a troubleshooting operation for a trouble (problem) that has occurred in the device so as to be able to communicate with the devices and the user terminals. The troubleshooting request server is characterized by having troubleshooting request means for selecting the desired person to carry out the troubleshooting operation for the trouble from the plural requestable persons on the basis of trouble information of the trouble that has occurred in the device, notifying the occurrence of the trouble to a request destination user terminal of the desired person, judging whether troubleshooting for the trouble has been completed or not on the basis of a response from the request destination user terminal, selecting a different desired person (different from the initially desired person) to carry out the troubleshooting operation for the trouble when it is judged that troubleshooting has not been completed, and notifying the occurrence of the trouble to a request destination user terminal of the different desired person.

With such a structure, the troubleshooting request server has effects and advantages equivalent to those of the device troubleshooting request system described in aspect 1.

According to aspect 14, there is provided a device troubleshooting request program for causing a computer to execute processing to request a desired person to carry out a troubleshooting operation for a trouble (problem) that has occurred in one or more devices used via a network, through a user terminal used by the desired person. The program is characterized in that it causes the computer to execute a troubleshooting request step of selecting the desired person to be requested to carry out the troubleshooting operation for the trouble from the plural requestable persons on the basis of trouble information of the trouble that has occurred in the device, notifying the occurrence of the trouble to a request destination user terminal of the desired person, judging whether troubleshooting for the trouble has been completed or not on the basis of a response from the request destination user terminal, selecting a different desired person (different from the initially desired person) to carry out the troubleshooting operation for the trouble when it is judged that troubleshooting has not been completed, and notifying the occurrence of the trouble to a request destination user terminal of the different desired person.

With such a structure, as the computer reads the program and executes the processing based on the program thus read, effects and advantages equivalent to those of the device troubleshooting request system described in aspect 1 are achieved.

According to aspect 15, there is provided a device troubleshooting requesting method for requesting a desired person to carry out a troubleshooting operation for a trouble (problem) that has occurred in one or more devices used via a network, through a user terminal used by the desired person. The device troubleshooting requesting method is characterized by including a troubleshooting request step of selecting the desired person to be requested to carry out the troubleshooting operation for the trouble from the plural requestable persons on the basis of trouble information of the trouble that has occurred in the device, notifying the occurrence of the trouble to a request destination user terminal of the desired person, judging whether troubleshooting for the trouble has been completed or not on the basis of a response from the request destination user terminal, selecting a different desired person (different from the initially desired person) to carry out the troubleshooting operation for the trouble when it is judged that troubleshooting has not been completed, and notifying the occurrence of the trouble to a request destination user terminal of the different desired person.

This has effects equivalent to those of the device troubleshooting request system described in aspect 1.

### BRIEF DESCRIPTION OF THE DRAWINGS

FIG. 1 is an overall structural view of a device troubleshooting request system.

FIG. 2 is an exemplary functional block diagram of a printer.

FIG. 3 is an exemplary functional block diagram of a troubleshooting request server.

FIG. 4 is an exemplary view showing the structure of trouble information DB.

FIG. 5 is an exemplary view showing the structure of a troubleshooting request destination information table.

FIG. 6 is an exemplary view showing a flowchart of troubleshooting processing based on a control program stored in advance in the ROM of the printer.

FIG. 7 is an exemplary view showing a flowchart of troubleshooting processing based on a control program stored in advance in the ROM of the troubleshooting request server.

FIG. 8 is an exemplary view showing a flowchart of troubleshooting request destination decision processing in the troubleshooting processing.

FIG. 9 is a view for explaining the generation of a request destination table.

FIG. 10 is an exemplary view showing a flowchart of troubleshooting request destination monitoring processing in the troubleshooting processing.

FIG. 11 is an exemplary view showing a flowchart of troubleshooting processing based on control programs stored in advance in the ROM of the computers of a general user terminal, management staff user terminal and service center terminal, as request destinations.

FIG. 12 is a view showing the content of troubleshooting request information sent by using an E-mail.

FIG. 13 is a view showing the content of a notification of confirmation of troubleshooting request sent by using an E-mail.

FIG. 14 is an exemplary view showing operation flows between the printer, troubleshooting request server and request destination computer in the troubleshooting processing.

### DETAILED DESCRIPTION

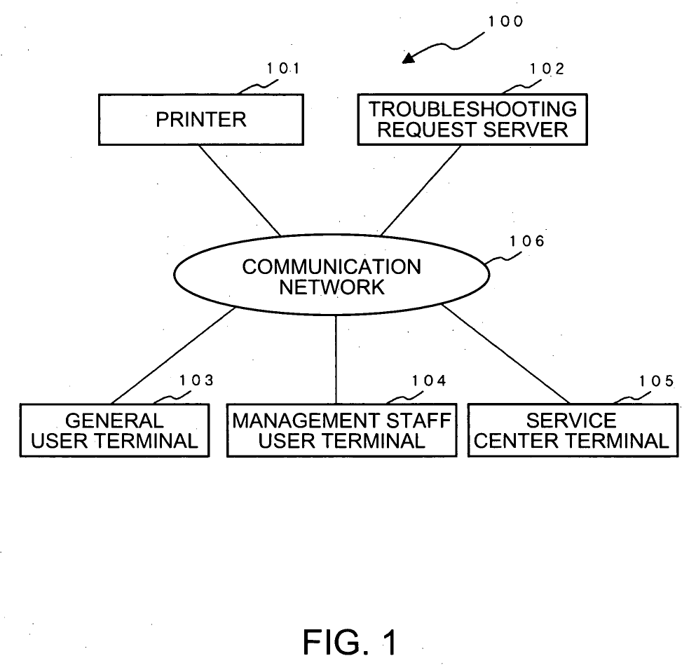

An embodiment of this invention will now be described with reference to the drawings. FIG. 1 is an overall structural view of a device troubleshooting request system. In the following description, a printer is used as an exemplary device. A device troubleshooting request system 100 has a printer 101, a troubleshooting request server 102, a general user terminal 103, a management staff user terminal 104, and a service center terminal 105, which can communicate with each other via a communication network 106.

The printer 101 is a device in which a trouble (problem) may occur. When a trouble (problem) occurs, the printer 101 sends information of the trouble that has occurred in it (hereinafter referred to as “trouble information”) to the troubleshooting request server 102. As the trouble information, a trouble ID identifying the type of trouble is sent together with device information identifying the printer 101 to the troubleshooting request server 102.

The troubleshooting request server 102 monitors the trouble that occurs in the printer 101 connected thereto via the communication network 106, then selects a desired person to be requested to carry out troubleshooting in accordance with the nature of the trouble (e.g., what the trouble is), and sends troubleshooting request information including what the trouble is and a troubleshooting method for the trouble to a request destination user terminal, which is the user terminal of the desired person. That is, when a trouble (problem) occurs in the printer 101, the troubleshooting request server 102 acquires trouble information of the trouble, judges a trouble level representing the seriousness of the trouble from the acquired trouble information, searches for requestable persons of a troubleshooting level corresponding to the judged trouble level, decides the order of requesting the plural requestable persons found by the search to carry out troubleshooting, selects a desired person to be requested to carry out troubleshooting in accordance with the decided request order, and sends troubleshooting request information to a request destination user terminal, which is the user terminal of the desired person. Moreover, when the response from the request destination user terminal to the troubleshooting request information sent is a request rejection or when there is no response, the next desired person, who is different from the initially desired person requested to carry out troubleshooting, is selected in accordance with the request order, and the troubleshooting request information is sent to the request destination user terminal of the next desired person. The request destination user terminal is at least one of the general user terminal 103, the management staff user terminal 104, and the service center terminal 105.

The general user terminal 103 is a user terminal used by a requestable person using the printer 101 (hereinafter referred to as “general user”) and requests the printer 101 to carry out print processing via the communication network 106. Among general users, there are users who have relatively advanced technical knowledge and can carry out maintenance of the printer 101.

The management staff user terminal 104 is also a general user terminal 103 and a user terminal used by a management staff user in charge of management of the printer 101. The management staff user has relatively advanced technical knowledge and can carry out maintenance of the printer 101. The service center terminal 105 is a user terminal used by a maintenance staff member of SI who delivered the printer 101 or a maintenance staff member at the service center of the manufacturer. The maintenance staff member at the service center can carry out maintenance and repair of the printer 101.

Although not shown, each of the printer 101, the troubleshooting request server 102, the general user terminal 103, the management staff user terminal 104 and the service center terminal 105 has a CPU for performing arithmetic processing and controlling the entire device on the basis of control programs, a ROM having the control programs for the CPU stored in a predetermined area in advance, a RAM for storing information read out from the ROM or the like and results of arithmetic processing necessary for arithmetic processes in the CPU, and an interface for input/output of information from/to external devices. The CPU, ROM, RAM and interface are interconnected by a bus, which is a signal line for transferring information, so that the CPU, ROM, RAM and interface can transmit and receive information.

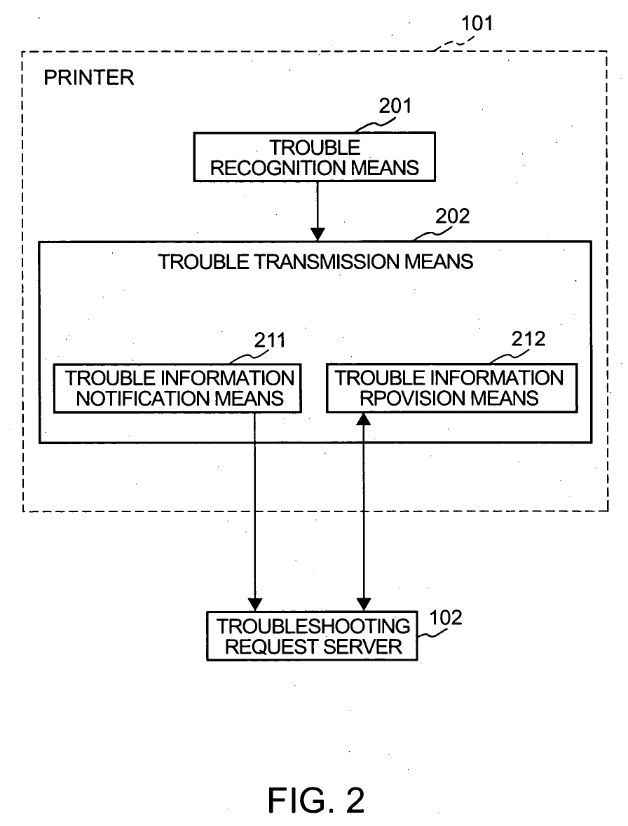

FIG. 2 is an exemplary functional block diagram of the printer 101. The printer 101 has trouble recognition means 201 and trouble transmission means 202. Further, the trouble transmission means 202 has trouble information notification means 211 and trouble information provision means 212. The trouble recognition means 201 detects shortage of expendables such as paper and ink, a paper jam, an abnormality of the machine and the like, using various sensors provided in the printer 101. The trouble recognition means 201 then recognizes that a trouble (problem) has occurred in the printer 101 and acquires trouble information of the trouble that has occurred.

The trouble transmission means 202 sends the trouble information acquired by the trouble recognition means 201 to the troubleshooting request server 102 via the interface. When an abnormality detected by the various sensors is recognized as a trouble (problem) that has occurred in the printer 101, the trouble information notification means 211 sends the trouble information of that trouble to the troubleshooting request server 102 from the printer 101. The trouble information provision means 212 sends the trouble information of the already recognized trouble that has occurred in the printer 101 to the troubleshooting request server 102 on the basis of a sending request from the troubleshooting request server 102.

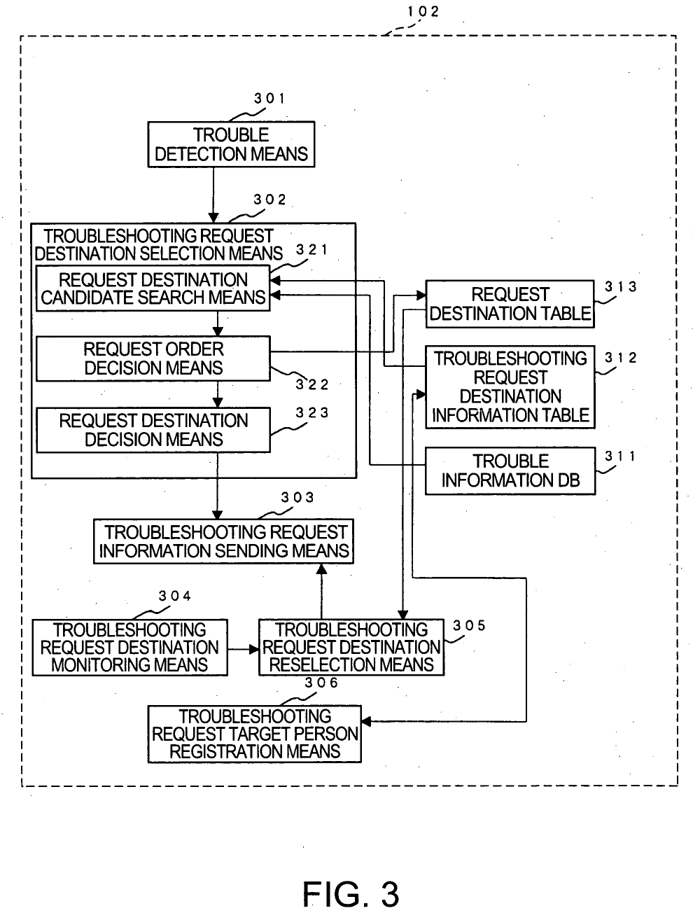

FIG. 3 is an exemplary functional block diagram of the troubleshooting request server 102. The troubleshooting request server 102 has trouble detection means 301, troubleshooting request destination selection means 302, troubleshooting request information sending means 303, troubleshooting request destination monitoring means 304, troubleshooting request destination reselection means 305, and troubleshooting request target person registration means 306. The trouble detection means 301 receives the trouble information of the trouble that has occurred in the printer 101 and the device information of the printer 101 from the trouble transmission means 202 of the printer 101. By making a trouble information sending request to the printer 101, the trouble detection means 301 receives the trouble information and the device information from the trouble transmission means 202 of the printer 101. Also when a trouble (problem) occurs, the trouble detection means 301 receives the trouble information and the device information from the trouble transmission means 202 of the printer 101. As the trouble information, a trouble ID is received, which is a symbol or number identifying the type of trouble.

The troubleshooting request destination selection means 302 selects plural requestable persons who can be requested to carry out troubleshooting on the basis of the trouble ID received by the trouble detection means 301, and selects a desired person to be notified of the occurrence of the trouble that has occurred, from the selected requestable persons. The troubleshooting request destination selection means 302 has request destination candidate search means 321, request order decision means 322, and request destination decision means 323.

The request destination candidate search means 321 acquires various kinds of information about the trouble that has occurred in the printer 101, using a trouble information database (hereinafter referred to as “trouble information DB”) 311, on the basis of the trouble ID received by the trouble detection means 301. The request destination candidate search means 321 also generates a request destination candidate table using a troubleshooting request destination information table 312 on the basis of the trouble level included in the acquired various kinds of information about the trouble. In the trouble information DB 311, various kinds of information about potential troubles are stored. In the troubleshooting request destination information table 312, user information about the requestable persons who can be requested to carry out troubleshooting and information about their user terminals are stored. In the request destination candidate table, user information of requestable persons who can be requested to carry out troubleshooting for the trouble that has occurred and information of their user terminals are stored.

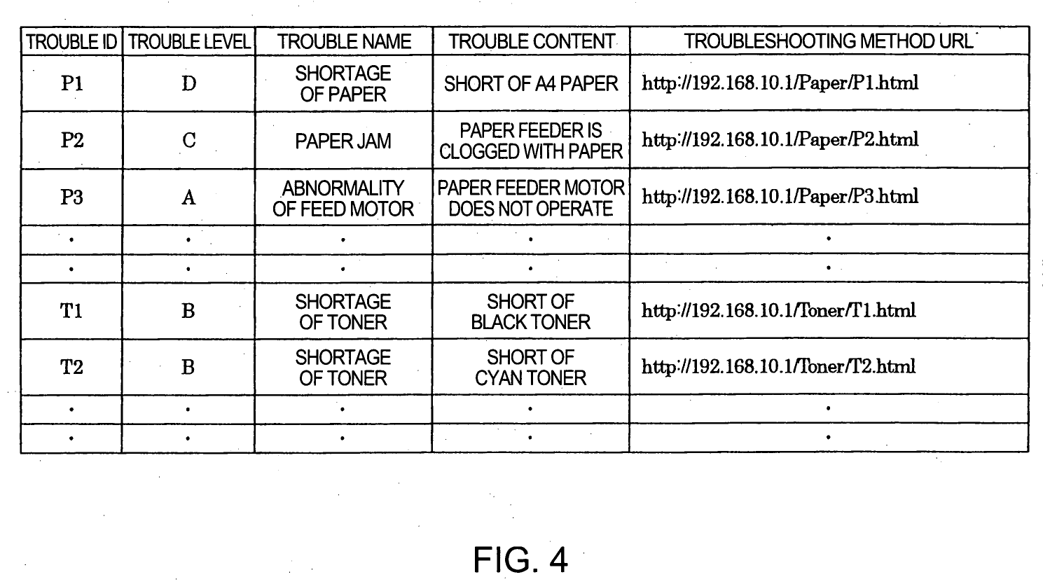

FIG. 4 shows an exemplary structure of the trouble information DB 311. As shown in FIG. 4, at least a trouble ID for univocally discriminating the type of trouble, trouble level representing the seriousness of the trouble, trouble name for discriminating the type of trouble from a human viewpoint, trouble content specifically showing what the trouble is, and information of troubleshooting method URL, which is URL of a web page showing a troubleshooting method for the trouble, are stored in the trouble information DB 311. In the following example, four trouble levels exist. Level A represents the most serious trouble, and level D represents the least serious trouble.

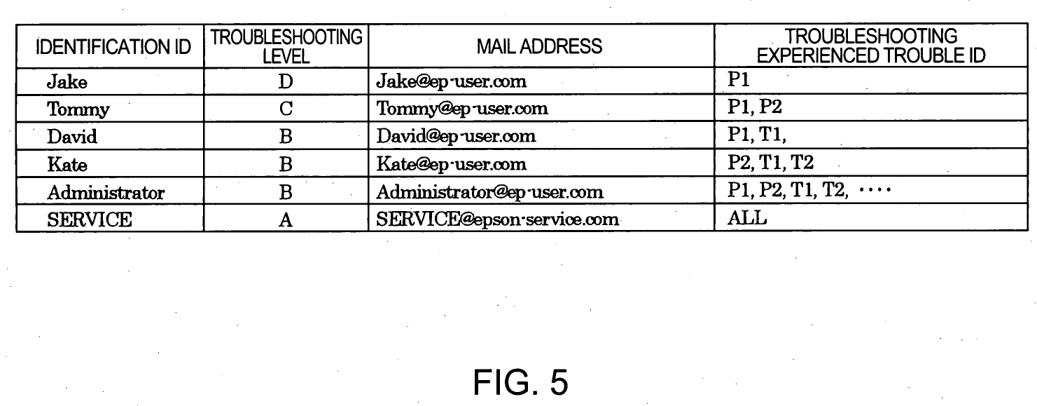

FIG. 5 shows an exemplary structure of the troubleshooting request destination information table 312. As shown in FIG. 5, at least an identification ID for identifying the requestable person and identifying the user terminal of the requestable person, troubleshooting level representing the trouble level for which the requestable person can carry out troubleshooting, mail address of the user terminal for notifying the requestable person, and a troubleshooting experienced trouble ID representing a trouble ID for which the requestable person has troubleshooting experience, are stored in the troubleshooting request destination information table 312.

The request order decision means 322 decides the request order among the plural requestable persons stored in the request destination candidate table generated by the request destination candidate search means 321, on the basis of candidate order decision rules, and generates a request destination table 313 in which user information of the requestable persons and information about their user terminals are stored in accordance with the decided request order. The candidate order decision rules are rules for deciding the request order among the requestable persons. These rules represent condition information of the requestable persons and the order of preference to the condition information. The condition information of the requestable persons may include, for example, the following conditions. (a) A requestable person who last used the printer: since the trouble occurred immediately after the requestable person used the printer, that person is likely to be responsible for the trouble and therefore can be easily requested to carry out troubleshooting. (b) A requestable person who has started the user terminal: this person may be near the printer. (c) A requestable person who has opened the printer setting screen: since there is a high possibility that this person will use the printer immediately, this person will be troubled very much when a trouble (problem) occurs and therefore it is likely that this person will be highly motivated to carry out troubleshooting. (d) A requestable person who has started an application program that can be printed: since there is a high possibility that this person will use the printer immediately, this person will be troubled very much when a trouble (problem) occurs and therefore it is likely that this person will be highly motivated to carry out troubleshooting. (e) A requestable person who is found present in the room from the scheduler: there is a high possibility that this person is present in the room. That is, requestable persons having no possibility of being present in the room are eliminated from the request destination candidates, and the request priority to a requestable person scheduled to be present in the room is raised. (f) A requestable person who frequently uses the device in which the trouble has occurred: since this person frequently uses the device, there is a high possibility that this person is near the device and therefore this person can be easily requested to carry out troubleshooting. Moreover, since this person often interacts with the device, this person is considered to have relatively advanced skill for maintenance, compared with the other requestable persons. (g) A requestable person who frequently uses the device when a trouble (problem) occurs: if the frequency of use varies among requestable persons by time slots and days of the week, there is a high possibility that this person uses the device when trouble occurs and therefore this person is likely to agree to carry out troubleshooting based on a preferential request. (h) A requestable person who has troubleshooting experience for the trouble that has occurred: since this person has troubleshooting experience for the trouble, there is a high possibility that this person will carry out troubleshooting faster than a requestable person who has no experience. (i) A requestable person who has no or little troubleshooting experience for the trouble that has occurred: a person who has little troubleshooting experience may be selected and trained to be a requestable person capable of troubleshooting. Quick recovery is achieved by raising the overall technical level for troubleshooting of all possibly requestable persons. (j) A requestable person which is a general user of a high troubleshooting level: recovery can be made quicker by preferentially selecting a person having a high troubleshooting level from among many general users. (k) A requestable person who is at a position near the device in which the trouble has occurred: this person need only move a short distance (which only takes a short time) to the printer in which the trouble has occurred. Moreover, since this person is near the device and can easily watch a troubleshooting method displayed on a display terminal such as a PC, this person can easily carry out the troubleshooting operation. (I) A requestable person at a portable request destination such as a notebook type personal computer: when a trouble (problem) occurs in the printer, this person can take the notebook type personal computer on which the troubleshooting method is displayed to the place where the trouble has occurred and can carry out troubleshooting while watching the troubleshooting method.

In this embodiment, since there are a large number of requestable persons of low troubleshooting level and these requestable persons can easily carry out troubleshooting, the persons of low troubleshooting level are preferentially selected, and persons who have troubleshooting experience for the trouble that has occurred are preferentially selected. The request destination decision means 323 selects a desired person to be requested to carry out troubleshooting on the basis of the request order in the request destination table 313 generated by the request order decision means 322, and decides the request destination user terminal of the desired person to whom troubleshooting request information is to be sent. When plural troubles of different types occur, a desired person is selected on the basis of trouble information of higher trouble level.

The troubleshooting request information sending means 303 sends troubleshooting request sending information including the trouble content of the trouble that has occurred in the printer 101 and the troubleshooting method for the trouble, to the request destination user terminal decided by the troubleshooting request destination selection means 302 or the request destination user terminal decided by the troubleshooting request destination reselection means 305 on the basis of the request order in the request destination table 313. When agreement response from the request destination user terminal to the troubleshooting request is received by the troubleshooting request destination monitoring means 304, troubleshooting request confirmation information is sent to the request destination user terminal.

The troubleshooting request destination monitoring means 304 monitors the response from the request destination user terminal to the troubleshooting request information sent by the troubleshooting request information sending means 303. When the response from the request destination user terminal is a notification of rejection on the troubleshooting request or there is no response from the request destination user terminal, the troubleshooting request destination reselection means 305 selects the next desired person different from the initially desired person requested to carry out troubleshooting on the basis of the request order in the request destination table 313, and decides the request destination user terminal of the next desired person to which the troubleshooting request information is to be sent. When the response from the request destination user terminal is a notification of agreement on the troubleshooting request, the troubleshooting request information sending means 303 is requested to send troubleshooting request confirmation information to the request destination user terminal.

The troubleshooting request target person registration means 306 registers user information about requestable persons who can carry out troubleshooting for the trouble that has occurred in the printer 101 and information of their user terminals, to the troubleshooting request destination information table 312 as shown in FIG. 5. That is, user information about requestable persons who use the respective user terminal of the general user terminal 103, the management staff user terminal 104 and the service center terminal 105 provided in the device troubleshooting request system 100, and information of the user terminals, are registered to the troubleshooting request destination information table 312.

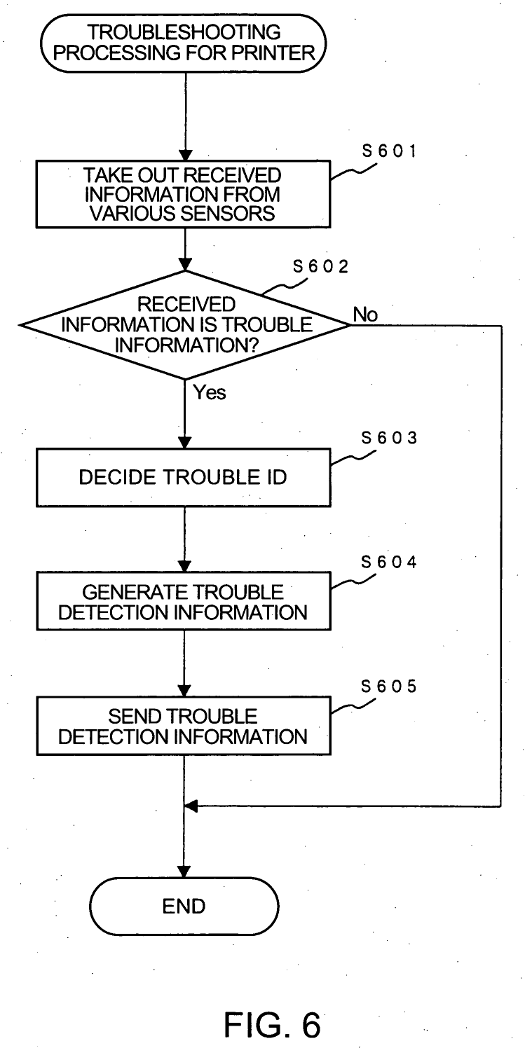

FIG. 6 is a flowchart showing an example of troubleshooting processing executed by a control program stored in advance in the ROM of the printer 101. As shown in FIG. 6, first, received information is acquired from various sensors (S601) and whether the received information is trouble information or not is judged (S602). If the received information is not trouble information (No at S602), the processing ends. If the received information is trouble information (Yes at S602), a trouble ID is decided (selected) on the basis of the received trouble information (S603) and trouble detection information including the decided trouble ID and the device information of the printer 101 is generated (S604) in order to notify the occurrence of the trouble to the troubleshooting request server 102. The generated trouble detection information is sent to the troubleshooting request server 102 (S605) and the processing ends.

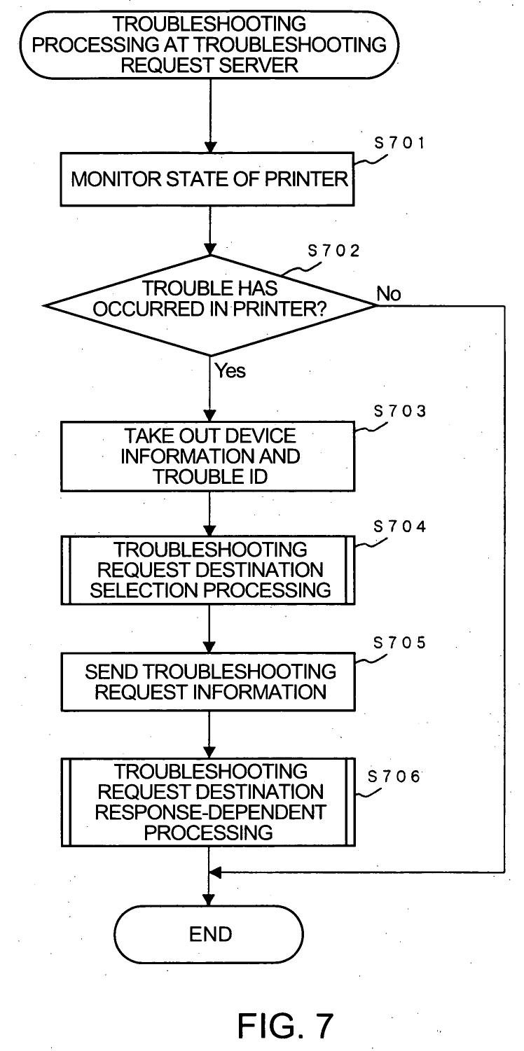

FIG. 7 is a flowchart showing an example of troubleshooting processing executed by a control program stored in advance in the ROM of the troubleshooting request server 102. As shown in FIG. 7, first, the state of the printer 101 is monitored (S701) and whether a trouble (problem) has occurred in the printer 101 or not is judged (S702). For example, periodic communication with the printer 101 is made to acquire the state of the printer 101, thereby judging whether a trouble (problem) has occurred or not. When a trouble (problem) occurs in the printer 101, trouble detection information is received and the occurrence of the trouble is recognized. If no trouble has occurred in the printer 101 (No at S702), the processing ends.

If a trouble (problem) has occurred in the printer 101 (Yes at S702), the device information and the trouble ID are taken out to identify the printer 101 in which the trouble has occurred, on the basis of the device information, and also to identify the trouble that has occurred, on the basis of the trouble ID (S703). Next, plural requestable persons who can be requested to carry out troubleshooting for the trouble that has occurred in the printer 101 are found by search on the basis of the acquired trouble ID, and the request order for requesting the requestable persons to carry out troubleshooting is decided in accordance with predetermined rules, and then a desired person to be requested to carry out troubleshooting is selected in accordance with the decided request order (S704). Next, troubleshooting request information including the trouble content of the trouble that has occurred in the printer 101 and the troubleshooting method for the trouble is sent to the request destination user terminal of the selected desired person (S705).

Next, the response from the request destination user terminal to the troubleshooting request information sent is monitored until a notification of completion of troubleshooting is received from the request destination user terminal. If the response from the request destination user terminal to the troubleshooting request information sent is a request rejection or if there is no response, the next desired person (different from a previously desired person requested to carry out troubleshooting) is selected in accordance with the request order decided at step S704, and the troubleshooting request information is sent to the request destination user terminal of the next desired person (S706). Then, the processing ends.

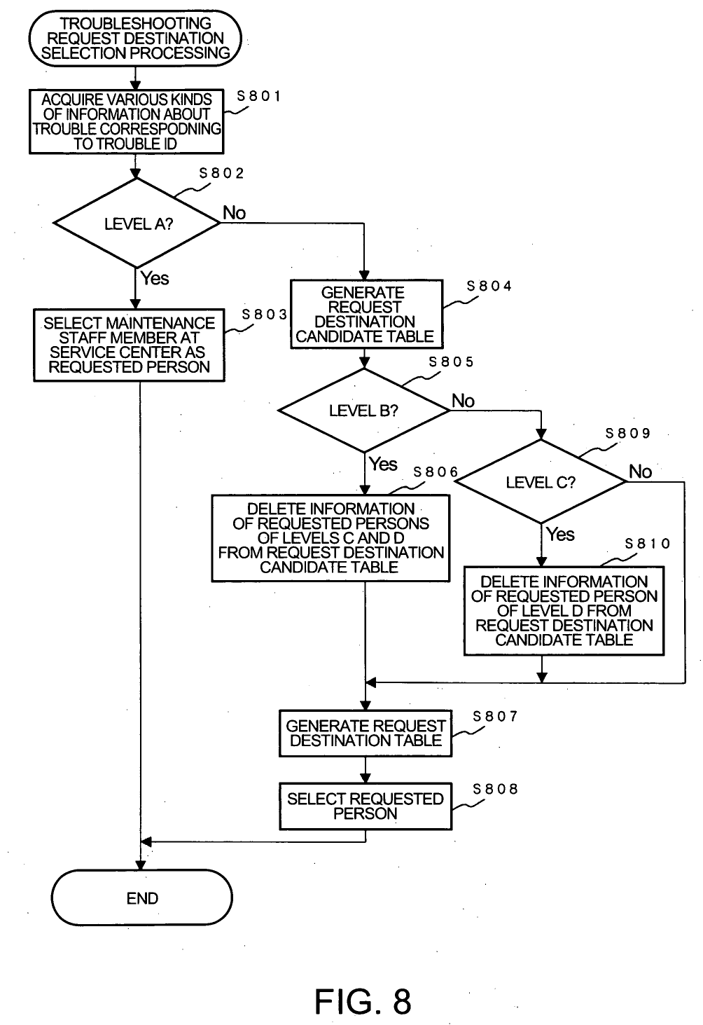

FIG. 8 is a flowchart showing an example of troubleshooting request destination selection processing in the troubleshooting processing at the troubleshooting request server 102. As shown in FIG. 8, first, the trouble information DB 311 is referred to on the basis of the trouble ID, and various kinds of information about the trouble including the trouble level are acquired (S801). Next, whether the acquired trouble level is level A or not is judged (S802). If the trouble level is level A (Yes at S802), the maintenance staff member at the service center is selected as a requested/desired person (S803) and the processing ends.

If the trouble level is not level A (No at S802), a request destination candidate table is generated (S804) and whether the trouble level is level B or not is judged (S805). If the trouble level is level B (Yes at S805), information about requestable persons of level C and level D is deleted from the request destination candidate table (S806). The request order for requesting the requestable persons to carry out troubleshooting is decided in accordance with the candidate order decision rules and the request destination table 313 according to the order is generated (S807). A desired person to be requested to carry out troubleshooting is selected on the basis of the generated request destination table 313 (S808) and the processing ends.

If the trouble level is not level B (No at S805), whether the trouble level is level C or not is judged (S809). If the trouble level is level C (Yes at S809), information about requestable persons of level D is deleted from the request destination candidate table (S810) and the processing shifts to step S807. If the trouble level is not level C (No at S809), the processing shifts to step S807.

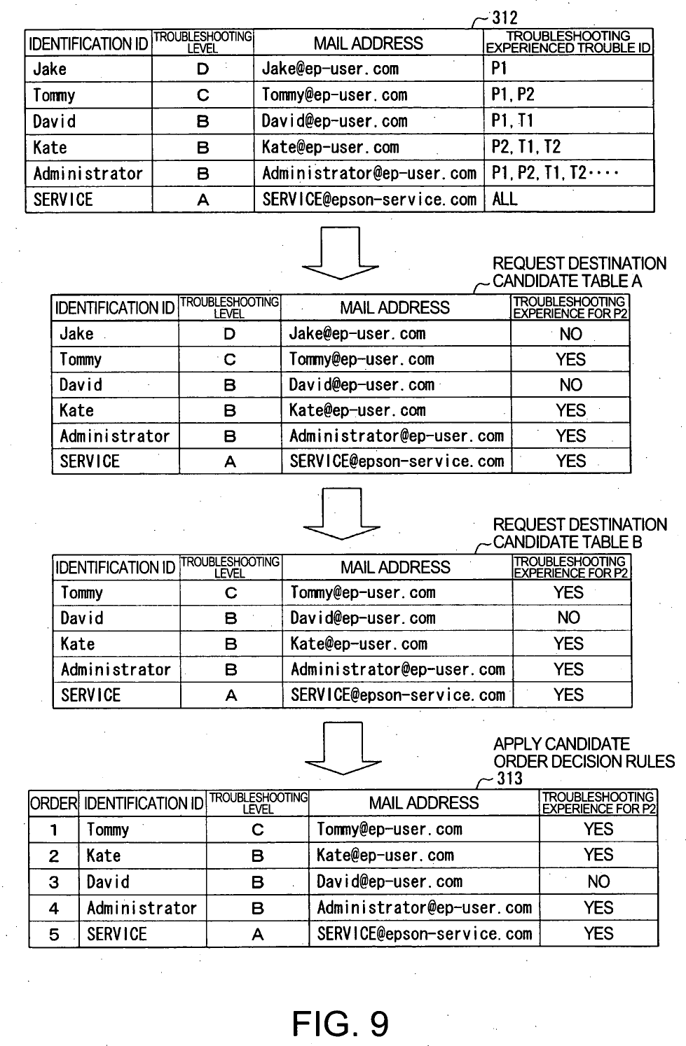

FIG. 9 is a view for explaining the generation of a request destination table. Here, the generation of a request destination table in the case where trouble P2 has occurred in the printer 101 will be described. Trouble P2 represents “paper jam” and its trouble level is “level C”. As an example of the candidate order decision rules, the following rules are used. A rule with a smaller rule number is considered to be a rule of higher priority. (Rule 1) A request should be sent in the order of general users, management staff users, and the service center. (Rule 2) The order should be replaced within each category of general users, management staff users, and the service center. (Rule 3) Persons having troubleshooting experience for a trouble (problem) that has occurred are preferentially selected and requested.

First, by the processing of steps S802 and S804 of FIG. 8, information about requestable persons is taken out from the troubleshooting request destination information table 312 to judge whether the requested persons have troubleshooting experience for trouble P2, and a request destination candidate table A is generated, as shown in FIG. 9. That is, the request destination candidate table A is a table showing confirmation of troubleshooting experience for P2 by each identification ID. For example, it is confirmed that a requestable person with the identification ID “Jake” has no troubleshooting experience for P2 and that a requestable person with the identification ID “Tommy” has troubleshooting experience for P2, and so on to generate the table.

Next, since the trouble level of trouble P2 is “level C”, a request destination candidate table B, that is, the request destination candidate table A from which the requestable person of level D has been deleted, is generated as shown in FIG. 9 by the processing of steps S805, S809 and S810 of FIG. 8. That is, the request destination candidate table B is a table of which the requestable person with the identification ID “Jake” has been deleted from the request destination candidate table A.

Finally, by the processing of step S807 of FIG. 8, the candidate order decision rules are applied to the generated request destination candidate table B to generate the request destination table 313, as shown in FIG. 9. That is, in the request destination candidate table B, a requestable person with the identification ID “David” who has no troubleshooting experience for trouble P2 and a requestable person with the identification ID “Kate” who has troubleshooting experience for trouble P2 are replaced in the order on the basis of rule 3, and the request destination table 313 is thus generated.

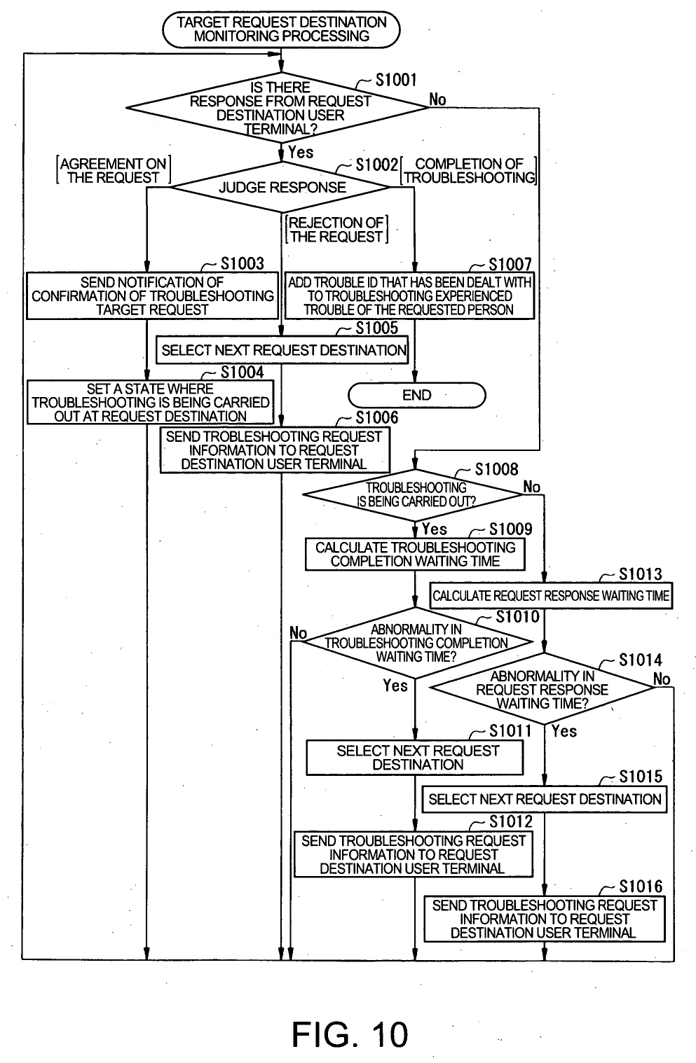

FIG. 10 is a flowchart showing an example of troubleshooting request destination response-dependent processing in the troubleshooting processing at the troubleshooting request server 102. As shown in FIG. 10, first, whether or not there is a response from the request destination user terminal is judged (S1001). If there is a response from the request destination user terminal (Yes at S1001), the content of the response is judged (S1002).

If the response from the request destination user terminal is a notification of response on the troubleshooting request (“agreement on the request” at S1002), a notification of confirmation of the troubleshooting request is sent to the request destination user terminal (S1063) and it is considered that troubleshooting is now being carried out at the request destination (S1004). Then, the processing goes back to step S1001 and waits for a predetermined time. If the response from the request destination user terminal is a notification of rejection of the troubleshooting request (“rejection of the request” at S1002), the next request destination user terminal is decided (S1005) on the basis of the request destination table 313 generated by the troubleshooting request destination decision processing of step S704 of FIG. 7. Next, troubleshooting request information is sent to the decided request destination user terminal (S1006). The processing goes back to step S1001 and waits for a predetermined time.

If the response from the request destination user terminal is a notification of completion of troubleshooting (“completion of troubleshooting” at step S1002), the trouble ID of the trouble that has been dealt with is added to the troubleshooting experienced trouble ID of the requestable person in the troubleshooting request destination information table 312 using the request destination user terminal (S1007), and the processing ends. If there is no response from the request destination user terminal (No at S1001), whether or not troubleshooting is being carried out at the request destination is judged (S1008). If troubleshooting is being carried out at the request destination (Yes at S1008), a troubleshooting completion waiting time, which is the time passed from the transmission of the notification of confirmation of the troubleshooting request, is calculated (S1009), and whether the troubleshooting completion waiting time has exceeded a predetermined completion waiting abnormality judging time or not is judged (S1010). If the troubleshooting completion waiting time has not exceeded the completion waiting abnormality judging time (No at S1010), the processing goes back to step S1001 and waits for a predetermined time.

If the troubleshooting completion waiting time has exceeded the completion waiting abnormality judging time (Yes at S1010), the next requestable person is selected on the basis of the request destination table 313 (S1011). Next, the troubleshooting request information is sent to the request destination user terminal of the selected requested person (S1012). The processing goes back to step S1001 and waits for a predetermined time. If troubleshooting is not being carried out at the request destination (No at S1008), a request response waiting time, which is the time passed from the transmission of the troubleshooting request information, is calculated (S1013), and whether or not the request response waiting time has exceeded a predetermined response waiting abnormality judging time is judged (S1014). If the request response waiting time has not exceeded the response waiting abnormality judging time (No at S1014), the processing goes back to step S1001 and waits for a predetermined time.

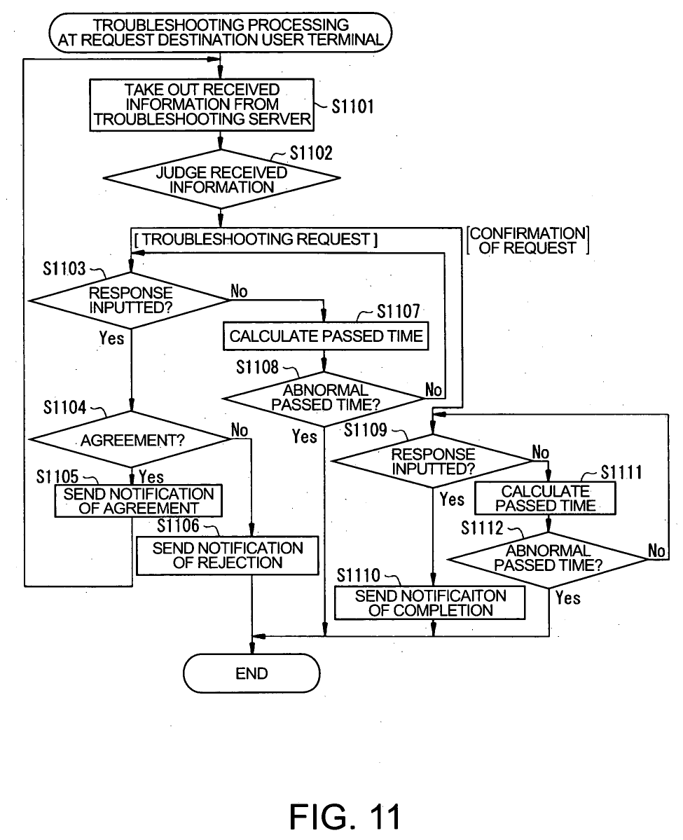

If the request response waiting time has exceeded the response waiting abnormality judging time (Yes at S1014), the next requestable person is selected on the basis of the request destination table 313 (S1015). Next, the troubleshooting request information is sent to the request destination user terminal of the selected requestable person (the desired person) (S1016). The processing then goes back to step S1001 and waits for a predetermined time. FIG. 11 is a flowchart showing an example of troubleshooting processing executed by a control program stored in advance in the ROM of the request destination user terminal, which is at least one of the general user terminal 103, the management staff user terminal 104 and the service center terminal 105.

As shown in FIG. 11, first, received information from the troubleshooting request server 102 is taken out (S1101) and the content of the received information thus taken out is judged (S1102). If the received information is troubleshooting request information for the printer 101 (“troubleshooting request” at S1102), whether or not a response to the troubleshooting request has been inputted by the requested person via an input device or the like is judged (S1103).

If a response has been inputted (Yes at S1103), whether the response is an agreement response or not is judged (S1104). If the response is an agreement response (Yes at S1104), a notification of agreement on the troubleshooting request is sent to the troubleshooting request server 102 (S1105). Then, the processing goes back to step S1101 and waits until a notification of confirmation is received from the troubleshooting request server 102. If the response is not an agreement response (No at S1104), a notification of rejection of the troubleshooting request is sent to the troubleshooting request server 102 (S1106) and the processing ends.

If no response has been inputted (No at S1103), the time passed from the reception of the received information form the troubleshooting request server 102 is calculated (1107) and whether the calculated time has exceeded a predetermined abnormality judging time or not is judged (S1108). If the calculated time has not exceeded the abnormality judging time (No at S1108), the processing goes back to step S1103 and waits for a predetermined time. On the other hand, if the calculated time has exceeded the abnormality judging time (Yes at S1108), the processing ends.

If the received information is a notification of confirmation of the troubleshooting request (“confirmation of request” at S1102), whether or not completion of recovery from the trouble of the printer 101 has been inputted by the requested person via an input device or the like is judged (S1109). If completion has been inputted (Yes at S1109), a notification of completion of the troubleshooting request is sent to the troubleshooting request server 102 (S1110), and the processing ends. On the other hand, if completion has not been inputted (No at S1109), the time passed from the reception of the received information from the troubleshooting request server 102 is calculated (S1111), and whether the calculated time has exceeded a predetermined abnormality judging time or not is judged (S1112). If the calculated time has not exceeded the abnormality judging time (No at S1112), the processing goes back to step S1109 and waits for a predetermined time. On the other hand, if the calculated time has exceeded the abnormality judging time (Yes at S1112), the processing ends.

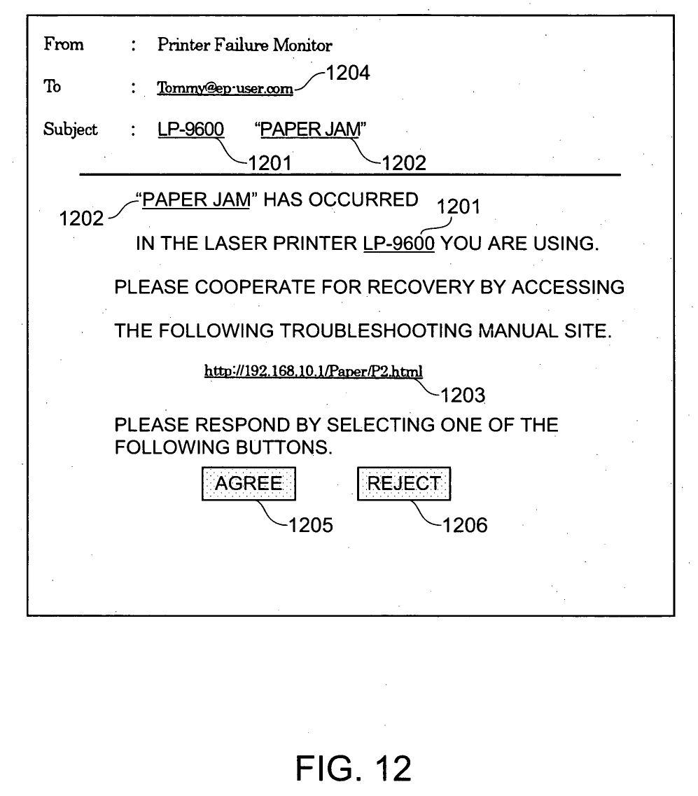

FIG. 12 shows the content of troubleshooting request information sent by using an E-mail. As shown in FIG. 12, device information 1201, a trouble name 1202, and a troubleshooting method URL 1203 are described in the texts of the E-mail. A request destination 1204 is described as the destination address, and the device information 1201 and trouble name 1202 are described as the title. As the requested person clicks, as a response to the troubleshooting request, an agreement button 1205 when agreeing on the troubleshooting request or clicks a rejection button 1206 when rejecting the troubleshooting request, a notification of response to the troubleshooting request is sent to the troubleshooting request server 102.

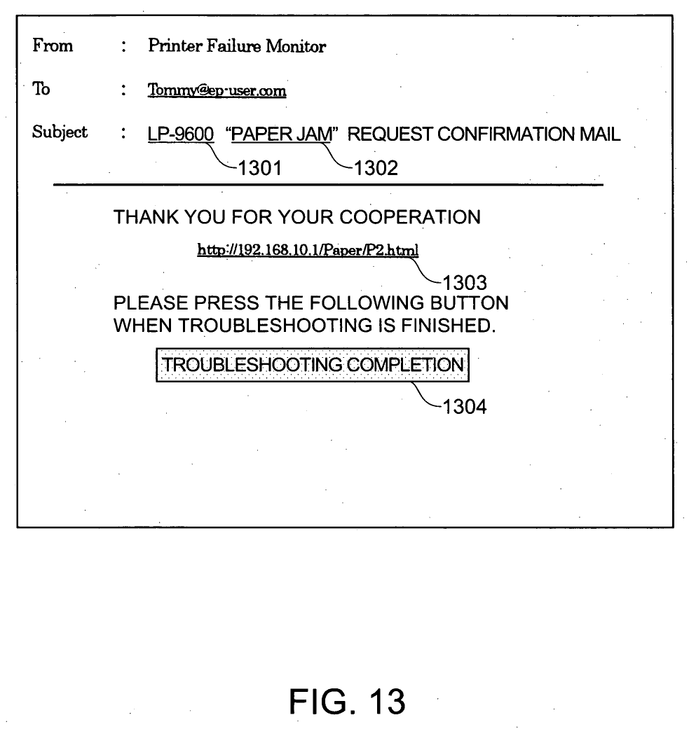

FIG. 13 shows the content of a notification of confirmation of the troubleshooting request sent by using an E-mail. As shown in FIG. 13, device information 1301, a trouble name 1302, and a troubleshooting method URL 1303 are described for confirmation of the troubleshooting request. As the requested person clicks a troubleshooting completion button 1304 when recovery is completed, a notification of completion is sent to the troubleshooting request server 102.

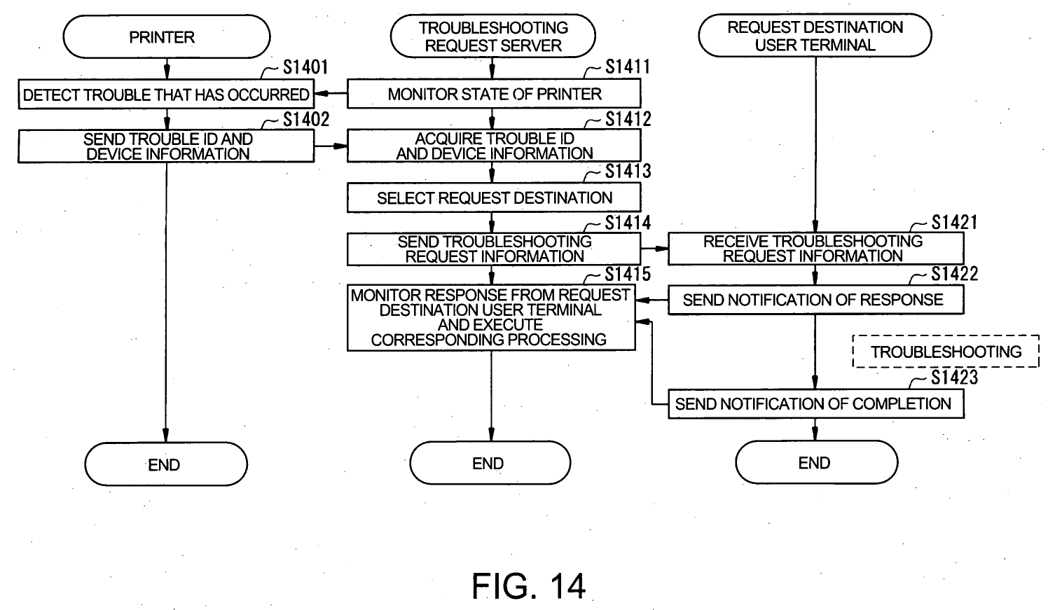

The operations of this embodiment will now be described. FIG. 14 is an exemplary flowchart showing the operations between the printer 101, the troubleshooting request server 102 and the request destination user terminal in the troubleshooting processing. As shown in FIG. 14, the printer 101 detects a trouble (problem) that has occurred in it (S1401). The printer 101 sends the trouble ID of the detected trouble together with the device information of itself to the troubleshooting request server 102 (S1402) and then ends the processing.

The troubleshooting request server 102 monitors the state of the printer 101 (S1411). When a trouble (problem) occurs, the troubleshooting request server 102 acquires the trouble ID of the trouble and the device information of the printer 1010 (S1412). The troubleshooting request server 102 also identifies the trouble on the basis of the trouble ID of the trouble received from the printer 10. Next, the troubleshooting request server 102 detects plural requestable persons who can be requested to carry out troubleshooting for the trouble that has occurred in the printer 101 on the basis of the trouble ID, then decides the request order of requesting the requestable persons in accordance with predetermined rules, and selects a desired person in accordance with the decided request order (S1413). The troubleshooting request server 102 sends troubleshooting request information to the request destination user terminal of the desired person (S1414).

The request destination user terminal receives the troubleshooting request information for the trouble that has occurred in the printer 101 from the troubleshooting request server 102 (S1421), and sends a response to the troubleshooting request inputted by the desired person via an input device to the troubleshooting request server 102 as a notification of response (S1422). That is, the request destination user terminal sends a notification of agreement on the troubleshooting request server 102 when the desired person agrees on the troubleshooting request, and sends a notification of rejection to the troubleshooting request server 102 when the desired person rejects the troubleshooting request. In the case where the desired person has agreed on the troubleshooting request, the request destination user terminal waits until recovery from the trouble is completed by the desired person in accordance with the received troubleshooting method, and sends completion of the recovery inputted by the desired person via the input device to the troubleshooting request server 102 as a notification of completion (S1423). The processing then ends.

The troubleshooting request server 102 monitors the response from the request destination user terminal to the troubleshooting request information sent, until the troubleshooting request server 102 receives a notification of completion of troubleshooting from the request user terminal. When the response from the request destination user terminal to the troubleshooting request information sent is rejection of the request or when there is no response, the troubleshooting request server 102 selects the next desired person in accordance with the request order decided at step S1413 and sends the troubleshooting request information to the request destination user terminal of the next desired person (S1415). The processing then ends.

As described above, since the device troubleshooting request system has the troubleshooting request means, and the troubleshooting request means has the trouble detection means, troubleshooting request destination selection means, troubleshooting request information sending means, troubleshooting request destination monitoring means, troubleshooting request destination reselection means and troubleshooting request target person registration means, whether the desired person requested to carry out troubleshooting has carried out troubleshooting or not can be confirmed on the basis of the response from the request destination user terminal. Therefore, troubleshooting is securely carried out, making it possible to reduce down time of the device in which the trouble has occurred, compared with the conventional technique.

When the desired person requested to carry out troubleshooting for the trouble that has occurred in the device cannot carry out troubleshooting or when the requested desired person is not present, another desired person can be requested to carry out troubleshooting. Therefore, it is possible to reduce down time of the device in which the trouble has occurred, compared with the conventional technique. Moreover, since general users, too, are requested to carry out troubleshooting, the burden of troubleshooting on requestable persons having relatively advanced skill such as the management staff user and the maintenance staff member at the service center can be shared by the general users.

While the troubleshooting request means is described as the troubleshooting request server 102 in the above-described embodiment, the troubleshooting request means can also be provided as a function of the device. That is, the troubleshooting request means can be provided in the printer 101. Moreover, while the device in which a trouble (problem) may occur is descried as the single printer 101 in the above-described embodiment, a plurality of the same devices or a plurality of different devices can be used as the devices in which a trouble (problem) may occur, in the device troubleshooting request system.

While it is described that only one request destination user terminal is used in the above-described embodiment, troubleshooting request information can be sent to plural request destination user terminals at a time. That is, since the majority of requestable persons who can be requested to carry out troubleshooting are general users, a request to plural requestable persons can prevent delay in recovery due to rejection responses from requested persons of the same troubleshooting level who are requested in order. If the management staff user is also notified of each troubleshooting request, the management staff user can learn information about a trouble (problem) immediately after the trouble occurs, and can grasp the state of agreement on or rejection of the troubleshooting request. Therefore, the management staff user can assist and execute troubleshooting while watching the state of the trouble.

While the response from the requested desired person to the troubleshooting request is an agreement response or rejection response in the above-described embodiment, it is also possible to include the next desired person in a notification of response when sending a rejection response. For example, it is possible to designate a request of troubleshooting to a desired person of a higher troubleshooting level or to designate a person judged as a requested person capable of carrying out troubleshooting. Moreover, user information of the requested person who has sent a rejection response can be attached to troubleshooting request information sent from the troubleshooting request server 102 to the request destination user terminal, as information for judging the response of the requested person to the troubleshooting request.

While the troubleshooting request server 102 receives completion of the troubleshooting operation from the request destination user terminal in the above-described embodiment, the troubleshooting request server 102 may receive recovery completion information from the device that has recovered. Although the user information of the requestable persons and information of their user terminals are registered to the troubleshooting request destination information table 312 by the troubleshooting request target person registration means 306, such information can be registered directly by the troubleshooting request server 102, or by the general user terminal 103 and the management staff user terminal 104 via the troubleshooting request server 102.

In the case of executing the above-described processing shown in the flowchart of FIG. 6, the control program stored in advance in the ROM of the printer 101 is executed. However, a program for executing each step, recorded on an information recording medium, may be read into the RAM and then executed. In the case of executing the above-described processing shown in the flowcharts of FIGS. 7, 8 and 10, the control program stored in advance in the ROM of the troubleshooting request server 102 is executed. However, a program for executing each step, recorded on an information recording medium, may be read into the RAM and then executed.

In the case of executing the above-described processing shown in the flowchart of FIG. 11, the control program stored in advance in the ROM of the request destination user terminal, which is at least one of the general user terminal 103, the management staff user terminal 104 and the service center terminal 105, is executed. However, a program for executing each step, recorded on an information recording medium, may be read into the RAM and then executed.

The information recording medium is a semiconductor recording medium such as a RAM or ROM, a magnetic storage-type recording medium such as an FD or HD, an optical reading system recording medium such as a CD, CDV, LD or DVD, or a magnetic storage/optical reading system recording medium such as an MO. Any information recording medium may be included as long as it is a computer-readable information recording medium, irrespective of the electronic, magnetic or optical reading method.

The above-described embodiment is for illustration and does not limit the scope of this invention. Therefore, those skilled in the art can employ embodiments in which each element or all the elements are replaced by equivalents, and these embodiments are also included in the scope of this invention.

1. A device troubleshooting request system comprising:
at least one monitored device that is monitored for troubles;
plural user terminals connected to the device so that the device and the user terminals can communicate with each other, the plural user terminals being used by plural requestable persons who can be requested to carry out a troubleshooting operation for a trouble that has occurred in the device;
troubleshooting request means for:
selecting a desired person from the plural requestable persons to carry out the troubleshooting operation, the selecting being based on trouble information of the trouble that has occurred in the device;
notifying a request destination user terminal of the desired person that the trouble has occurred;
judging whether the troubleshooting operation for the trouble has been completed based on a response from the request destination user terminal;
selecting a different desired person if the troubleshooting operation has not been completed; and
notifying the request destination user terminal of the different desired person that the trouble has occurred.

2. The device troubleshooting request system as claimed in claim 1, wherein the troubleshooting request means further comprises:
trouble detection means for detecting device information identifying the device in which the trouble has occurred and trouble information for identifying the type of the trouble;
troubleshooting request destination selection means for selecting the desired to be requested to carry out the troubleshooting operation for the trouble from the plural requestable persons based on the trouble information detected by the trouble detection means;
troubleshooting request information sending means for sending troubleshooting request information to request the troubleshooting operation for the trouble that has occurred in the device to the request destination user terminal of the desired person;
troubleshooting request destination monitoring means for monitoring a response from the request destination user terminal to which the troubleshooting request information has been sent by the troubleshooting request information sending means; and
troubleshooting request destination reselection means for judging whether the troubleshooting operation has been completed based on the response from the request destination user terminal and selecting the different desired person if the troubleshooting operation has not been completed.

3. The device troubleshooting request system as claimed in claim 2, wherein the troubleshooting request means further comprises:
troubleshooting request target person registration means for storing, in predetermined storage means, user information of the desired person and information of the request destination user terminal of the desired person for selecting the desired person to carry out the troubleshooting operation for the trouble, and wherein:
the troubleshooting request destination selection means selects the desired person to carry out the troubleshooting operation for the trouble from the plural requestable persons based on the trouble information and the user information; and
the troubleshooting request information sending means sends the troubleshooting request information to the request destination user terminal based on the information of the user terminal corresponding to the selected desired person.

4. The device troubleshooting request system as claimed in claim 2, wherein the troubleshooting request destination selection means further comprises:
request destination candidate search means for searching the plural requestable persons to carry out the troubleshooting operation for the trouble based on the trouble information;
request order decision means for deciding a request order for requesting the plural requestable persons from the request destination candidate search means to carry out the troubleshooting operation for the trouble; and
request destination decision means for deciding the desired person to be requested to carry out the troubleshooting operation for the trouble based on the request order from the request order decision means.

5. The device troubleshooting request, system as claimed in claim 4, wherein the request destination candidate search means sets, in advance, a trouble level representing a seriousness rank of the trouble for each trouble and a troubleshooting level representing the trouble level for which each of the requestable persons can carry out troubleshooting, and selects the desired person with the troubleshooting level corresponding to the trouble level of the trouble.

6. The device troubleshooting request system as claimed in claim 4, wherein a person who used the device within a predetermined past time period and who used the device most recently is advanced in the request order by the request order decision means.

7. The device troubleshooting request system as claimed in claim 4, wherein the request order decision means acquires troubleshooting experience information representing a degree of troubleshooting experience of the requestable persons for the trouble from predetermined storage means, and decides the request based on the acquired troubleshooting experience information.

8. The device troubleshooting request system as claimed in claim 2, wherein the troubleshooting request destination reselection means selects the different desired person to carry out the troubleshooting operation for the trouble based on the request order decided by the request order decision means when the response from the request destination user terminal to which the troubleshooting request information for the trouble was previously sent is at least one of:
a rejection response; and
when there is no response from the request destination user terminal after a predetermined time.

9. The device troubleshooting request system as claimed in claim 2, wherein the troubleshooting request destination reselection means selects the different desired person to carry out the troubleshooting operation for the trouble based on the request order decided by the request order decision means when there is no response showing completion of the troubleshooting operation for the trouble from the request destination user terminal after a predetermined time even if the response from the request destination user terminal to which the troubleshooting request information for the trouble has been sent is an agreement response.

10. The device troubleshooting request system as claimed in claim 2, wherein the troubleshooting request destination reselection means selects the different desired person to carry out the troubleshooting operation for the trouble based on a request search condition made by the desired person and appended to a rejection response when the response from the request destination user terminal to which the troubleshooting request information for the trouble has been sent is a rejection response.

11. The device troubleshooting request system as claimed in claim 2, wherein the troubleshooting request destination reselection means selects a requested person designated by the desired person and appended to a rejection response when the response from the request destination user terminal to which the troubleshooting request information for the trouble has been sent is a rejection response.

12. The device troubleshooting request system as claimed in claim 8, wherein the troubleshooting request destination reselection means selects a plurality of different desired persons to carry out the troubleshooting operation for the trouble.

13. A troubleshooting request server connected to one or more monitored devices that are monitored for trouble and to plural user terminals used by plural requestable persons who can be requested to carry out a troubleshooting operation for the trouble so as to be able to communicate with the devices and the user terminals, the troubleshooting request server comprising:
troubleshooting request means for:
selecting a desired person to be requested to carry out the troubleshooting operation for the trouble from the plural requestable persons, the selecting being based on trouble information of the trouble that has occurred in the device;
notifying a request destination user terminal of the selected desired person that the trouble has occurred;
judging whether the troubleshooting operation for the trouble has been completed based on a response from the request destination user terminal;
selecting a different desired person to carry out the troubleshooting operation for the trouble if the troubleshooting has not been completed; and
notifying a request destination user terminal of the selected different desired person that the trouble has occurred.

14. A device troubleshooting request program for causing a computer to execute processing to request a desired person to carry out a troubleshooting operation for a trouble that has occurred in one or more devices used via a network through a user terminal used by the desired person, the program comprising:
means for causing the computer to execute a troubleshooting request step of:
selecting the desired person to be requested to carry out the troubleshooting operation for the trouble from plural requestable persons based on trouble information of the trouble that has occurred in the device;
notifying a request destination user terminal of the selected desired person that the trouble has occurred;
judging whether the troubleshooting operation for the trouble has been completed based on a response from the request destination user terminal;
selecting a different desired person to carry out the troubleshooting operation for the trouble if the troubleshooting operation has not been completed; and
notifying a request destination user terminal of the selected different desired person that the trouble has occurred.

15. A device troubleshooting requesting method for requesting a desired person to carry out a troubleshooting operation for a trouble that has occurred in one or more devices used via a network through a user terminal used by the desired person, the device troubleshooting requesting method comprising:
a troubleshooting request step of selecting the desired person to be requested to carry out the troubleshooting operation for the trouble from plural requestable persons based on trouble information of the trouble that has occurred in the device;
notifying a request destination user terminal of the desired person that the trouble has occurred;
judging whether the troubleshooting operation for the trouble has been completed based on a response from the request destination user terminal;
selecting a different desired person to carry out the troubleshooting operation for the trouble if the troubleshooting operation has not been completed; and
notifying a request destination user terminal of the different desired person that the trouble has occurred.
